(19) United States
(12) Patent Application Publication
(10) Pub. No.: US 2009/0210327 A1
(43) Pub. Date: Aug. 20, 2009

(54) System and method for cash flow prediction

(75) Inventor: Abraham Meidan, Tel Aviv (IL)

Correspondence Address: DR. D. GRAESER LTD., 9003 FLORIN WAY, UPPER MARLBORO, MD, 20772, US

(73) Assignee: WizSoft Inc., New York, NY (US)

(21) Appl. No.: 12/071,302

(22) Filed: Feb. 20, 2008

(51) Int. Cl. G06Q 10/00; G06F 17/18

(52) U.S. Cl. 705/30

(57) ABSTRACT

A system and a method for predicting future cash flow of a business according to at least one parameter of the business, in addition to the actual (prior and/or current) cash flow itself. The at least one parameter may optionally include but is not limited to payment time required to receive payment from a client, payment time required for payment to a supplier, seasonality, payment times according to a plurality of clients and/or suppliers, payment times according to a plurality of different types of clients and/or suppliers, earnings of the business, or an analyzed parameter, or a combination thereof.

### FIELD OF THE INVENTION

The present invention relates to a system and a method for cash flow prediction, and in particular, to such a system and method which enable a company or other organization to predict future cash flow with regard to debits and credits.

### BACKGROUND OF THE INVENTION

Businesses forecast their cash flow for various aims such as determining when a certain payment may be made or when a loan should be taken. Such forecasting is required in order to enable the business to meet financial obligations while remaining solvent.

The standard cash flow report is based on the following items:
Payments that the business issued that have not been yet cleared in the bank.
Payments that the business received that have not been yet cleared in the bank
Non-paid invoices that the business issued and their due dates, as well as the extent to which they are overdue
Non-paid invoices that the business received and their due dates, as well as the extent to which they are overdue
Expected sales and expenses such as future payroll, rent etc.
The balance in the cash and the bank

The report calculates the expected balance in the bank on a daily, weekly or monthly basis in the future according to these items.

A more advanced system takes into consideration the average delay of payment per customer (or supplier) and postpones the expected dates of payment according to these averages.

U.S. Pat. No. 6,138,102 describes a method for determining when the cash flow falls below a predicted baseline in order to make a payment to cover the difference to the business. In other words, it relates to an insurance calculation for businesses which are insured against cash flow problems. However, the cash flow prediction which is performed is based very simply on the previous known cash flow of the business, without any special factors derived from the operation of the business and/or the environment of the business.

There are two types of cash flow reports for businesses; one type is issued with an annual report on the entire balance sheet, including profit and loss statements. As used herein, the term cash flow relates to available money to the business, for example including actual money in one or more bank accounts.

Still, in many cases the forecasted cash flow deviates from the actual cash flow. The deviation is the result of factors such as unexpected future sales, unexpected expenses or failure of a customer to pay as expected. These unexpected factors can lead to insolvency on the part of the business.

### SUMMARY OF THE INVENTION

There is an unmet need for, and it would be highly useful to have, a system and a method for accurately predicting future cash flow for a business. There is also an unmet need for, and it would be useful to have, such a system and method in which prediction of future cash flow is adjusted and/or tailored according to at least one parameter of the business.

The present invention overcomes these drawbacks of the background art by providing a system and method for. predicting future cash flow of a business according to at least one parameter of the business, in addition to the actual (prior and/or current) cash flow itself. The at least one parameter may optionally include but is not limited to payment time required to receive payment from a client (and/or optionally typical payment times for payment from a particular client), payment time required for payment to a supplier, seasonality, payment times according to a plurality of clients and/or suppliers, payment times according to a plurality of different types of clients and/or suppliers, or an analyzed parameter, or a combination thereof.

Preferably, the cash flow for a specified period in the past, which is similar to the current or future period for which cash flow is to be predicted, is used as a baseline. More preferably, the similarity for the cash flow for the period in the past is determined by the business, which indicates such a similarity; alternatively the selection of a similar period may optionally be made automatically. At least one parameter is then preferably used to adjust the previous cash flow in order to construct the predicted cash flow. Optionally and most preferably, the process is performed iteratively, such that a previous prediction is compared to the actual cash flow experienced by the business.

The term “analyzed parameter” preferably refers to a parameter that is heuristically derived from an analysis of past performance of the business. Such an analyzed parameter may optionally be performed by focusing on one aspect of the cash flow, such as payments in or payments out; on a plurality of aspects of the cash flow, or on all aspects of the cash flow. The analysis may optionally be performed in two stages, in which important or significant component(s) of the cash flow are identified in a first stage and then these component(s) are further analyzed in a second stage to form at least one analyzed parameter.

According to some embodiments the type of analysis includes but is not limited to, any type of statistical analysis (such as for example a Monte Carlo simulation or statistical regression) or any type of heuristic analysis, such as for example a neural network analysis.

As used herein, the term “business” refers to any company or organization for which cash flow is at least one business requirement and with at least partially computerized bookkeeping, whether for profit or non-profit.

Unless otherwise defined, all technical and scientific terms used herein have the same meaning as commonly understood by one of ordinary skill in the art to which this invention belongs. The materials, methods, and examples provided herein are illustrative only and not intended to be limiting. Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, any type of mobile communication device, a PDA (personal data assistant), a pager, TV decoder, game console, digital music player, ATM (machine for dispensing cash), POS credit card terminal (point of sale), electronic cash register. Any two or more of such devices in communication with each other, and/or any computer in communication with any other computer, may optionally comprise a “computer network”.

By “online”, it is meant that communication is performed through an electronic communication medium, including but not limited to, telephone voice communication through the PSTN (public switched telephone network), cellular telephones or a combination thereof; data communication according to any type of wireless communication protocol, including but not limited to SMS, MMS, EMS and the like; exchanging information through Web pages according to HTTP (HyperText Transfer Protocol) or any other protocol for communication with and through mark-up language documents; exchanging messages through e-mail (electronic mail), messaging services such as ICQ™ for example, and any other type of messaging service; any type of communication using a computational device as previously defined; as well as any other type of communication which incorporates an electronic medium for transmission.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic block diagram of an exemplary, illustrative system according to the present invention;

FIG. 2 shows a flowchart of an exemplary, illustrative method for predicting cash flow for a business; and

FIG. 3 shows another flowchart of an exemplary, illustrative method for predicting cash flow for a business.

### DESCRIPTION OF THE PREFERRED EMBODIMENTS

The present invention is of a system and method for predicting future cash flow of a business according to at least one parameter of the business, in addition to the actual (prior and/or current) cash flow itself. The at least one parameter may optionally include but is not limited to payment time required to receive payment from a client, payment time required for payment to a supplier, seasonality, payment times according to a plurality of clients and/or suppliers, payment times according to a plurality of different types of clients and/or suppliers, earnings of the business, or an analyzed parameter, or a combination thereof.

Preferably, the cash flow for a specified period in the past, which is similar to the current or future period for which cash flow is to be predicted, is used as a baseline. More preferably, the similarity for the cash flow for the period in the past is determined by the business, which indicates such a similarity; alternatively the selection of a similar period may optionally be made automatically. At least one parameter is then preferably used to adjust the previous cash flow in order to construct the predicted cash flow. Optionally and most preferably, the process is performed iteratively, such that a previous prediction is compared to the actual cash flow experienced by the business.

According to some embodiments the type of analysis includes but is not limited to, any type of statistical analysis (such as for example a Monte Carlo simulation or statistical regression) or any type of heuristic analysis, such as for example a neural network analysis.

Non-limiting examples of suitable parameters, in addition to or in place of the parameters described above, include payments that the business issued that have not been yet cleared in the bank; payments that the business received that have not been yet cleared in the bank; non-paid invoices that the business issued and their due dates; over-due non-paid invoices that the business issued and the extent to which they are overdue; likelihood of payment of any overdue invoices owed to the business and (if possible) a potential future date of payment; non-paid invoices that the business received and their due dates; over-due non-paid invoices that the business received and the extent to which they are overdue; expected sales and expenses such as future payroll, rent etc.; the balance of cash (physical money, checks, or other monetary instruments and the like, which have not yet been deposited in the bank) and also the balance of money in the bank. Optionally and more preferably, a plurality of parameters are selected for inclusion in the analysis.

The principles and operation of the present invention may be better understood with reference to the drawings and the accompanying description.

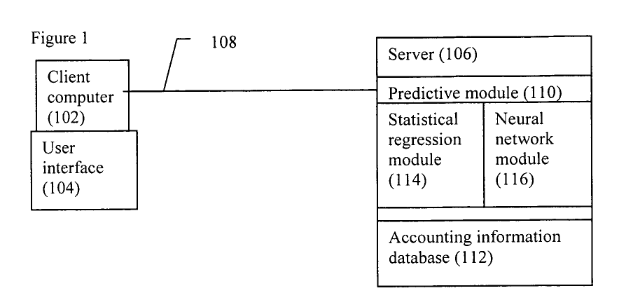

Referring now to the drawings, FIG. 1 shows a schematic block diagram of an exemplary, illustrative system according to the present invention. As shown, a system 100 preferably features a client computer 102, operating a user interface 104. User interface 104 preferably enables the user (not shown) to communicate with a server 106 through a network 108, which is preferably some type of computer network. User interface 104 may optionally be a web browser or other software for displaying mark-up language documents and/or for communicating through HTTP, in which case server 106 preferably comprises a HTTP server (not shown). In any case, user interface 104 communicates with a predictive module 110 operated by server 106. Predictive module 110 is preferably also in communication with an accounting information database 112 for storing accounting information.

Accounting information database 112 preferably includes information relating to the accounts of the business (not shown) which form business parameters for the business, including but not limited to one or more of information concerning invoices for which payment is owed by the business and invoices for which payment is owed to the business; the due date for any such invoices; payments that the business issued that have not been yet cleared in the bank; payments that the business received that have not been yet cleared in the bank; expected sales and expenses such as future payroll, rent etc.; and information concerning a deposit account, including: the identity of the owner of the deposit account; the monetary value of funds held in a deposit account (i.e., the deposit account balance); individual transactions in the deposit account, including deposits and withdrawals.

Accounting information database 112 also preferably stores previous cash flow information, more preferably broken down by period, and optionally also stores previously predicted cash flow information.

Predictive module 110 preferably analyzes the one or more business parameters, in combination with the cash flow information for at least a previous period, in order to predict cash flow for a current or future period. Preferably, the previous period is selected to be similar to the current or future period for which prediction is desired. Such a selection may optionally be made automatically by predictive module 110 or alternatively may optionally be made manually by the business or user. If the selection is performed automatically, optionally a clustering algorithm is used to find a similar period. In either case, preferably such factors as seasonality are included in the decision as to which period to select.

Predictive module 110 preferably features at least one of a statistical regression module 114 and/or a neural network module 116. Optionally both may be included as shown. Statistical regression module 114 performs statistical regression on the previous cash flow information, preferably in combination with at least one business parameter. If previous predictions of cash flow are available, statistical regression module 114 preferably also incorporates such previous predictions.

For example, statistical regression module 114 may optionally consider all transactions performed in the past year as the comparison period. Each period of a few months, for example, could then be considered for performing a cash flow prediction, in that such a prediction could optionally be performed according to cash flow information available at the start of each such period. The predicted cash flow could then be compared to the actual cash flow at the end of each period. This process is preferably performed more than once. The difference between the predicted and actual cash flows could then be calculated. The difference is a dependent variable. Statistical regression module 114 then preferably determines a regression formula that correctly predicts the difference(s). Such a regression formula could then optionally and preferably be used to adjust a cash flow prediction based on cash flow information from a previous period. If statistical regression is used, then revenue growth of the business is also accounted for.

Neural network module 116 preferably uses a neural network to analyze the previous cash flow with the at least one business parameter, which may optionally be used to adjust one or more weights in the model. For example, as for the above description for statistical regression module 114, one or more (but preferably a plurality) of cash flow predictions for previous periods are preferably performed. The difference between the predicted and observed cash flows may then preferably be fed to neural network module 116, in order to “train” the neural network regarding the best interpretation of previous cash flow information. Optionally information regarding one or more business parameters may also be provided for training the neural network. Future cash flow predictions by neural network module 116 would then incorporate this information through the actions of the neural network, leading to a more accurate method of predicting future cash flows from a previous period.

Of course, the above embodiment is intended only to be exemplary; it is possible that, for example, rather than a client-server arrangement, all activities could occur on the user computer, optionally including storage of accounting information in a database and the like.

Also other types of algorithms may optionally be used, such as genetic algorithms, a plurality of decision trees and the like, in addition or in place of the above two examples. For example, the “WizWhy” and “WizRule” softwares (WizSoft, Inc) are able to automatically determine all of the “if-then” rules in data; WizWhy is also able to locate interesting features in the data. Such software could optionally be adapted to the above prediction of cash flow, particularly to determine which one or more business parameters are actually significantly affecting the predicted or actual cash flow of the business. Also, one or more additional business parameters could optionally be determined in order to assist with making an accurate future cash flow prediction.

Furthermore, one or more methods may optionally be used to determine whether the predicted cash flow is likely to be accurate. For example, U.S. Pat. No. 6,311,173, entitled “Pattern recognition using generalized association rules”, owned in common with the present application and with at least one inventor in common, describes a method for determining whether a given item in a population of items is likely to have a certain value for a particular attribute. Such a method could optionally be adapted, for example to determine whether the adjusted prediction from the statistical regression formula and/or the neural network is more likely to be accurate.

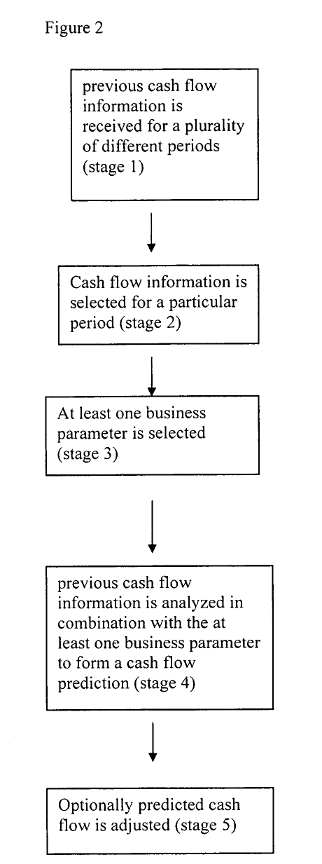

FIG. 2 shows a flowchart of an exemplary, illustrative method for predicting cash flow for a business. In stage 1, previous cash flow information is received for a plurality of different periods. In stage 2, cash flow information is selected for a particular period. The selection may optionally be made automatically or manually, as previously described. In stage 3, at least one business parameter is selected according to which the previous cash flow information is adjusted for performing a prediction of current or future cash flow. In stage 4, the previous cash flow information is analyzed in combination with the at least one business parameter to form a cash flow prediction. Optionally, such analysis is performed according to one or more of statistical regression or a neural network. In stage 5, optionally the predicted cash flow is adjusted according to a previous cash flow prediction in comparison to the actual cash flow, such that the adjustment is performed according to any inaccuracy of the previous prediction.

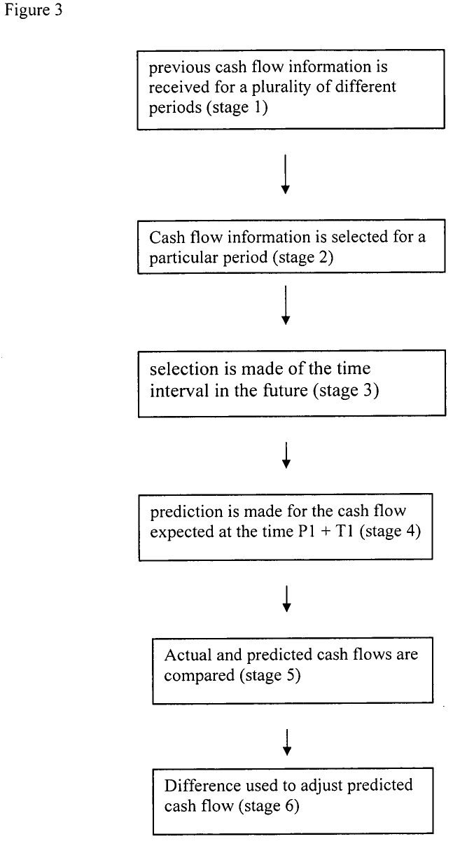

FIG. 3 shows another flowchart of another exemplary, illustrative method for predicting cash flow for a business. In this method, stages 1 and 2 are performed as for FIG. 2. The period for which the cash flow information is selected is referred to as “P1”. Next, in stage 3, a selection is made of the time interval in the future for which the predicted cash flow is to be valid; for example, the selection may optionally be made with regard to the number of months in the future. The selection may optionally be made automatically or manually. This time interval is referred to as “T1”.

In stage 4, a prediction is made for the cash flow expected at the time interval equivalent to T1 after the period P1, or at the time P1+T1. This prediction may optionally be made according to any of the methods described herein.

In stage 5, the actual cash flow observed at the time P1+T1 is compared to the predicted cash flow. If there is a difference, then this difference is optionally used to adjust the predicted cash flow for the desired future time interval (for example, the current time plus T1) in stage 6.

Stages 1-6 may optionally be performed a plurality of times, in which case the average difference between the actual and predicted cash flows may be determined according to the confidence interval, to determine the correct predicted cash flow from the previously observed cash flow at the selected previous period.

Also optionally, stage 6 may further include one or more of the methods described herein for predicting cash flow, including but not limited to adjustment according to one or more business parameters, statistical regression, a neural network model and so forth. For such a combination, preferably the predicted cash flow is first adjusted according to such one or more methods, after which the difference calculated in stage 5 and/or the average difference is preferably used to further adjust the predicted cash flow.

The cash flow prediction preferably also relates to future payments which have been guaranteed to external parties but which have not yet been executed. For example, in some countries, such future payments are made by providing a check with a future date, such that the check cannot be honored until the future date. In other countries, such future payments are made with a dated bank guarantee, which enable payment to be guaranteed by a certain date. These monetary obligations are preferably included in the cash flow prediction.

While the invention has been described with respect to a limited number of embodiments, it will be appreciated that many variations, modifications and other applications of the invention may be made.

What is claimed is:

1. A method for predicting cash flow for a business comprising:
Providing cash flow information for a plurality of previous periods;
Selecting cash flow information for one of said plurality of previous periods according to a degree of similarity of said period to a future period for predicting cash flow;
Analyzing said cash flow information for at least said selected one of said plurality of previous periods to construct a prediction model; and
Predicting future cash flow according to said prediction model.

2. The method of claim 1, wherein said prediction model comprises statistical regression.

3. The method of claim 2, wherein said analyzing said cash flow information comprises:
Determining a time difference between the present and said future period;
Predicting cash flow at a second previous period that is future to said selected one of said plurality of previous periods, determined according to said time difference, to form a previous predicted cash flow;
Comparing said previous predicted cash flow to said actual cash flow at said period; and
Determining a statistical regression formula according to said comparing.

4. The method of claim 3, wherein said determining said time difference, said predicting said cash flow and said comparing said previous predicted cash flow are performed a plurality of times for said determining said statistical regression formula.

5. The method of claim 1, wherein said prediction model comprises a neural network.

6. The method of claim 5, wherein said analyzing said cash flow information comprises:
Determining a time difference between the present and said future period;
Predicting cash flow at a second previous period that is future to said selected one of said plurality of previous periods, determined according to said time difference, to form a previous predicted cash flow;
Comparing said previous predicted cash flow to said actual cash flow at said period to determine a difference; and
Training said neural network according to said difference.

7. The method of claim 6, wherein said determining said time difference, said predicting said cash flow and said comparing said previous predicted cash flow are performed a plurality of times for said training said neural network.

8. The method of claim 6, wherein said selecting cash flow information for said selected one of said plurality of previous periods further comprises selecting at least one business parameter; and wherein said training said neural network is also performed according to said at least one business parameter.

9. The method of claim 8, wherein said business parameter is selected from the group consisting of payment time required to receive payment from a client, typical payment times for payment for one or more particular clients, payment time required for payment to a supplier, seasonality, payment times according to a plurality of clients and/or suppliers, payment times according to a plurality of different types of clients and/or suppliers, an analyzed parameter, and a combination thereof.

10. The method of claim 9, wherein said analyzed parameter is determined heuristically from a previous performance of the business.

11. The method of claim 10, wherein said analyzed parameter is determined according to identifying at least one significant component of cash flow; and further analyzing said at least one significant component to form said at least one analyzed parameter.

12. The method of claim 1, wherein said prediction model comprises an average cash flow difference between a predicted cash flow and an actual cash flow, such that said predicted cash flow is adjusted according to said average cash flow difference.

13. The method of claim 12, wherein said analyzing said cash flow information comprises:
Performing a plurality of predictions of cash flow according to a plurality of cash flow information for a plurality of previous periods;
Comparing said plurality of predictions for said plurality of previous periods to a plurality of actual cash flows for said plurality of previous periods; and
Determining said average cash flow difference within a confidence interval according to said comparing.

14. The method of claim 1, wherein said selecting cash flow information for said selected one of said plurality of previous periods further comprises selecting at least one business parameter; and wherein said analyzing said cash flow information is also performed according to said at least one business parameter.

15. The method of claim 14, wherein said business parameter is selected from the group consisting of payment time required to receive payment from a client, typical payment times for payment for one or more particular clients, payment time required for payment to a supplier, seasonality, payment times according to a plurality of clients and/or suppliers, payment times according to a plurality of different types of clients and/or suppliers, an analyzed parameter, and a combination thereof.

16. The method of claim 15, wherein said analyzed parameter is determined heuristically from a previous performance of the business.

17. The method of claim 16, wherein said analyzed parameter is determined according to identifying at least one significant component of cash flow; and further analyzing said at least one significant component to form said at least one analyzed parameter.

18. A system for predicting cash flow for a business comprising:
A client computer for operating a user interface and for receiving a user selection of a previous similar period for cash flow information;
A server, comprising a predictive module, for predicting cash flow for the business according to said cash flow information of said previous similar period and according to said predictive module; and
A network for connecting said client computer and said server.

19. The system of claim 18, wherein said predictive module comprises a neural network module, said neural network module comprising a neural network trained according to a plurality of previous predictions for a plurality of previous periods and a comparison between said previous predictions and said actual cash flows.

20. The system of claim 18, wherein said predictive module comprises a statistical regression module, said statistical regression module determining a statistical regression formula according to a plurality of previous predictions for a plurality of previous periods and a comparison between said previous predictions and said actual cash flows.
